(19) United States
(12) Patent Application Publication
(10) Pub. No.: US 2006/0125851 A1
(43) Pub. Date: Jun. 15, 2006

(54) Thermal transfer image forming apparatus using low voltage differential signaling, and method of forming image using the same

(75) Inventor: In-su Hwang, Metropolitan-city (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/280,441

(22) Filed: Nov. 17, 2005

(30) Foreign Application Priority Data
Dec. 15, 2004 (KR) 10-2004-0106542

(51) Int. Cl. B41J 29/38

(52) U.S. Cl. 347/5

(57) ABSTRACT

Provided are an image forming apparatus having a thermal head which prints an image on a medium by applying heat to the medium, and a method printing the image using the image forming apparatus, that decrease the number of data lines between the control unit and the thermal head since data is transmitted between the thermal head and the control unit using the serial low voltage differential signals. The image forming apparatus includes: a data input unit which receives image data of an image that is to be printed; a control unit which includes a low voltage differential signaling (LVDS) driver, generates control signals to drive a thermal head based on the image data, converts the control signals into low voltage differential signals, and outputs the low voltage differential signals using the LVDS driver; and a thermal head unit that includes an LVDS receiver which receives the low voltage differential signals output from the control unit, converts the low voltage differential signals into the control signals, and prints the image by applying heat to a medium according to the control signals.

This application claims the benefit under 35 U.S.C. §119(a) of Korean Patent Application No. 10-2004-0106542, filed on Dec. 15, 2004 in the Korean Intellectual Property Office, the entire contents of which are incorporated herein by reference.

### BACKGROUND OF THE INVENTION

1. Field of the Invention

The present invention relates to an image forming apparatus having a thermal head that prints an image by applying head to a medium. More particularly, the present invention relates to an image forming apparatus that transmits and receives data by serial low voltage differential signaling (LVDS) between a thermal head and a control unit that generates control signals to control the operation of the thermal head, and a method of forming an image using the same.

2. Description of the Related Art

Generally, an image forming apparatus converts a document written by a user via an application program or an image photographed by the user using, for instance, a digital camera into encoded data. Then, the image forming apparatus outputs the data onto media making it visible to the user.

Recently, many printing apparatuses have been developed to print high quality images. Thermal transfer printing apparatuses can include a thermal head that applies heat to an ink ribbon contacting a medium, thus transferring ink from the ink ribbon onto the medium to print an image. Alternatively, thermal transfer printing apparatuses can include a thermal head that applies heat to a medium on which an ink layer that changes to a predetermined color in response to heat is formed, thus printing an image.

The thermal head includes a plurality of heaters with a predetermined resistance R. The heaters apply heat, which is generated when the heaters receive a predetermined voltage VHD, to the medium, thereby printing an image on the medium. The number of heaters must be increased to achieve high quality printing, and, accordingly, the number of control signals to control the operation of a thermal head with an increased number of heaters must be increased.

However, more data lines are required when the number of clock signals, strobe signals, latch signals, and data signals used to control the thermal head increases. As a result, noise produced by the signals and power consumption increase. Further it becomes difficult to configure a printed circuit board (PCB) to provide the control signals, and interference of electromagnetic waves occurs more readily. A need exists for a thermal image forming apparatus that decreases the number of data lines needed, improves efficiency, and reduces noise and interference.

### SUMMARY OF THE INVENTION

The present invention provides a thermal image forming apparatus that transmits and receives data by serial low voltage differential signaling (LVDS) between a thermal head and a control unit that generates control signals to control the operation of the thermal head, and a method of forming an image using the same.

According to an exemplary aspect of the present invention, there is provided an image forming apparatus, comprising: a data input unit which receives image data of an image that is to be printed; a control unit which comprises an LVDS driver, generates control signals to drive a thermal head based on the image data, converts the control signals into low voltage differential signals, and outputs the low voltage differential signals using the LVDS driver; and a thermal head unit that comprises an LVDS receiver which receives the low voltage differential signals output from the control unit, converts the low voltage differential signals into the control signals, and prints the image by applying heat to a medium according to the control signals.

The thermal head unit may further comprise a converter which converts the received low voltage differential signals into transistor-transistor logic (TTL) level signals or may further comprise a converter which converts the low voltage differential signals into complementary metal oxide semiconductor (CMOS) level signals.

The control unit may further comprise a serial converting unit which converts the control signals into serial signals, and the thermal head unit may further comprise a parallel converting unit which converts the control signals into parallel signals.

The LVDS driver may comprise two current sources and two data input ports, and the LVDS receiver may comprise three comparators and an OR gate.

The thermal head unit may comprise a plurality of thermal heads which apply heat to the medium according to the control signals.

According to another exemplary aspect of the present invention, there is provided a method of forming an image using an image forming apparatus. The method includes: receiving image data of the image that is to be printed; generating control signals to drive the thermal head based on the image data; converting the control signals into low voltage differential signals and outputting the low voltage differential signals; receiving the low voltage differential signals and converting the low voltage differential signals into the control signals; and printing the image by applying heat onto the medium with the thermal head according to the received control signals.

The method may further comprise converting the control signals into serial signals, converting the received low voltage differential signals into CMOS level signals, or converting the received low voltage differential signals into TTL level signals.

The method may further comprise converting the received control signals into parallel signals.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an image forming apparatus according to an exemplary embodiment of the present invention;

FIG. 2 is a schematic circuit diagram of a low voltage differential signaling (LVDS) driver and an LVDS receiver for transmitting and receiving low voltage differential signals in the image forming apparatus illustrated in FIG. 1 according to an exemplary embodiment of the present invention;

FIG. 3 is a circuit diagram of a LVDS driver and an LVDS receiver for transmitting and receiving low voltage differential signals in the image forming apparatus illustrated in FIG. 1 according to another exemplary embodiment of the present invention;

FIGS. 4A through 4D are schematic circuit diagrams for describing the operation of the LVDS driver and the LVDS receiver illustrated in FIG. 3;

FIG. 5 is a block diagram of a control unit and a thermal head illustrated in FIG. 1; and

FIG. 6 is a flow chart illustrating a method of forming an image according to an exemplary embodiment of the present invention.

Throughout the drawings, the same or similar elements are denoted by the same reference numbers.

### DETAILED DESCRIPTION OF THE EXEMPLARY EMBODIMENTS

The present invention will now be described more fully with reference to the accompanying drawings, in which exemplary embodiments of the invention are shown.

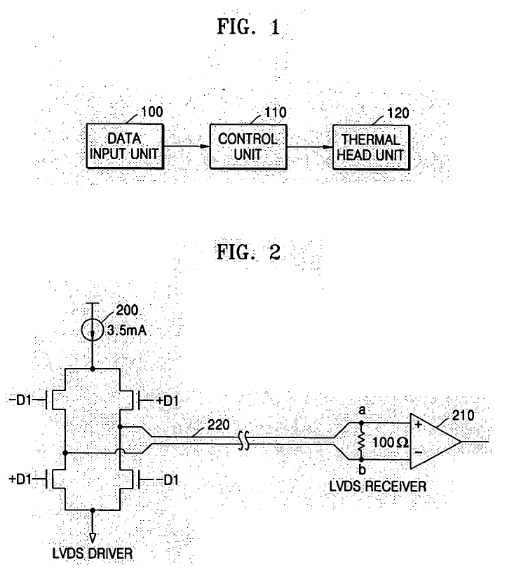

FIG. 1 is a block diagram of an image forming apparatus according to an exemplary embodiment of the present invention. The image forming apparatus comprises a data input unit 100, a control unit 110, and a thermal head unit 120.

The data input unit 100 receives image data that is to be printed from, for example, a personal computer (PC), a digital camera, or a personal digital assistant (PDA). The control unit 110 generates control signals to control the operation of the thermal head unit 120 according to the input image data, and then converts the control signals into serial signals.

The control unit 110 comprises a low voltage differential signaling (LVDS) driver (not shown) at an output port. The control unit 110 outputs the generated control signals after converting them into low voltage differential signals. In addition, the control unit 110 may further comprise an LVDS receiver (not shown) to receive low voltage differential signals output from the thermal head unit 120.

The thermal head unit 120 comprises an LVDS receiver (not shown) to receive the low voltage differential signals output from the control unit 110. Also, the thermal head unit 120 may further comprise an LVDS driver (not shown) to output the low voltage differential signals to the control unit 110.

FIG. 2 is a circuit diagram of the LVDS driver included in the control unit 110 and the LVDS receiver included in the thermal head unit 120 for transmitting and receiving the low voltage differential signals according to an embodiment of the present invention. The LVDS driver comprise a current source 200 which generates a 3.5 mA current, receives an input signal D1, and converts the input signal D1 into a low voltage differential signal. The low voltage differential signal is transmitted through a transmitting medium 220. The transmitting medium 220 may be a cable or a conductive pattern on a circuit board.

The LVDS receiver includes an OP amp 210, and receives the low voltage differential signal. In the operation of the LVDS driver and the LVDS receiver, if the input signal D1 is at a logic 1, a 3.5 mA current flows from a to b through a resistor with a resistance of 1.00 Ω in the LVDS receiver and a 350 mV drop occurs across the resistor. Thus, the output signal of the OP amp 210 has a 350 mV and is at logic 1. If the input signal D1 is logic 0, current flows from b to a, and thus the output signal of the OP amp 210 is at logic 0.

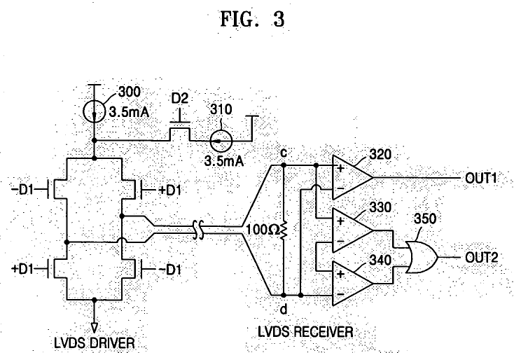

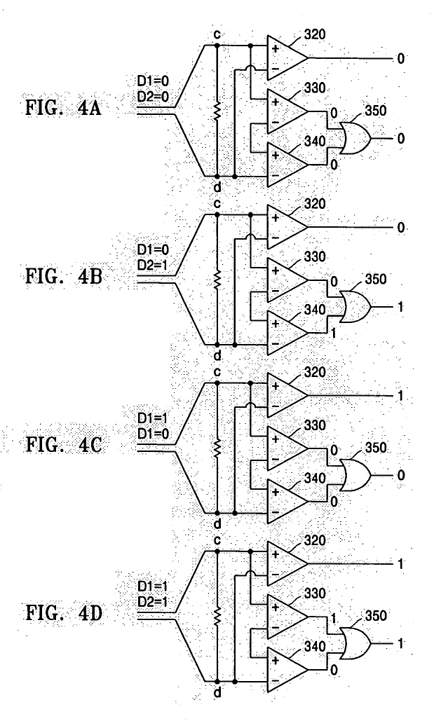

FIG. 3 is a circuit diagram of the LVDS driver included in the control unit 110 and the LVDS receiver included in the thermal head unit 120 for transmitting and receiving low voltage differential signals according to another exemplary embodiment of the present invention. The LVDS driver includes two current sources 300 and 310, and receives input signals D1 and D2 via two input ports. The LVDS receiver includes comparators 320, 330, and 340, and an OR gate 350. The comparators 320, 330, and 340 may be OP amps as illustrated in FIG. 3. The operations of the LVDS driver and the LVDS receiver will be described in more detail with reference to circuit diagrams illustrated in FIGS. 4A through 4D.

FIG. 4A illustrates the case where the input signals D1 and D2 are both logic 0. A 3.5 mA current flows from d to c through a resistor of the LVDS receiver with a resistance of 1.00 Ω, and a 350 mV drop occurs across the resistor. Thus, the output from the first OP amp 320 and the output from the OR gate 350 are at logic 0.

FIG. 4B illustrates when the input signal D1 is 0 and the input signal D2 is 1. 7.0 mA current flows from d to c through the resistor, and a 700 mV drop occurs across the resistor. Thus, the output from the first OP amp 320 is at logic 0, and the output from the third OP amp 340 is at logic 1. As a result, the output of the OR gate 350 is at logic 1.

FIG. 4C illustrates the case where the input signal D1 is logic 1 and the input signal D2 is logic 0. A 3.5 mA of current flows from d to c through the resistor, and a 350 mV drop occurs across the resistor. Thus, the output from the first OP amp 320 is at logic 1, and the output from the second OP amp 330 and the output from the third OP amp 340 are at logic 0. As a result, the output from the OR gate 350 is at logic 0.

FIG. 4D illustrates the case where the input signals D1 and D2 are at logic 1. A 7.0 mA current flows from d to c through the resistor, and a 700 mV drop occurs across the resistor. Thus, the output from the first OP amp 320 is at logic 1, the output from the second OP amp 330 is at logic 1, and the output from the third OP amp 340 is at logic 0. As a result, the output from the OR gate 350 is at logic 1.

Therefore, 2 bit signals can be transmitted during each cycle of a clock signal using the LVDS driver and the LVDS receiver illustrated in FIG. 3.

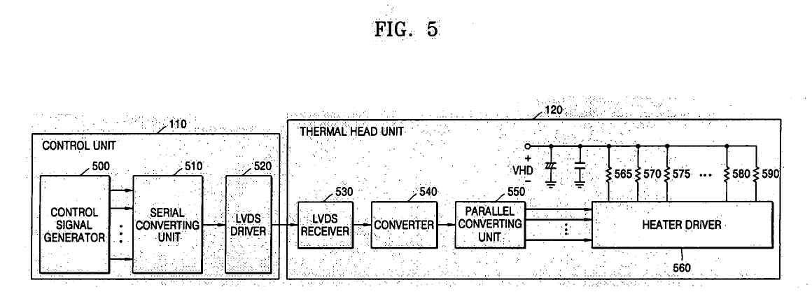

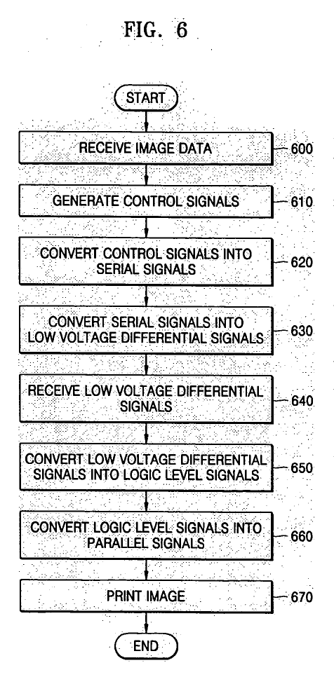

FIG. 5 is a block diagram of the control unit 110 and the thermal head unit 120 illustrated in FIG. 1. Referring to FIG. 5, the control unit 220 comprises a control signal generator 500, a serial converting unit 510, and an LVDS driver 520. The thermal head unit 120 comprises an LVDS receiver 530, a converter 540, a parallel converting unit 550, a heater driver 560, and a plurality of heaters 565, 570, 575, . . . , 580, and 590. The operation of the image forming apparatus illustrated in FIG. 5 will be described together with a method of forming an image illustrated in FIG. 6.

Referring to FIGS. 5 and 6, the data input unit 100 receives image data of an image that is to be printed (600). The control signal generator 500 generates control signals, such as a clock signal, a strobe signal, a latch signal, and a data signal (610). The serial converting unit 510 converts the control signals into serial control signals (620). The serial converting unit 510 may convert the input control signals into serial control signals using a register. The LVDS driver 520 converts the serial control signals into low voltage differential signals and outputs the low voltage differential signals (630).

The LVDS receiver 530 receives the low voltage differential signals output from the LVDS driver 520 (640). The converter 540 converts the received low voltage differential signals into logic level signals (650). The logic lever signals may be a transistor-transistor level (TTL) signal, which has a 5V level, or a complementary metal oxide semiconductor (CMOS) level signal, which has a 3.3V level.

The parallel converting unit 550 converts the serial logic level control signals into parallel signals in which the serial control signals are divided into the clock signal, the strobe signal, the latch signal, and the data signal (660). The heater driver 560 receives the parallel control signals and controls each of the plurality of heaters 565, 570, 575, . . . , 580, and 590 using the input control signals. The heaters 565, 570, 575, . . . , 580, and 590 apply heat to a medium under the control of the heater driver 560 and print an image on the medium (670).

As described above, according to the present invention, in a heat transfer image forming apparatus using low voltage differential signalling and a method of printing an image using the same, the number of data lines between a control unit, which generates control signals to control the operation of a thermal head, and the thermal head can be decreased by transmitting data between the thermal head and the control unit as serial low voltage differential signals. Consequently, the efficiency of the image forming apparatus can be improved, the production costs of the image forming apparatus can be decreased, and electromagnetic waves generated when transmitting data can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image forming apparatus, comprising:
a data input unit which receives image data of an image that is to be printed;
a control unit which comprises a low voltage differential signaling (LVDS) driver, generates control signals to drive a thermal head based on the image data, converts the control signals into low voltage differential signals, and outputs the low voltage differential signals using the LVDS driver; and
a thermal head unit that comprises an LVDS receiver which receives the low voltage differential signals output from the control unit, converts the low voltage differential signals into the control signals, and prints the image by applying heat to a medium according to the control signals.

2. The image forming apparatus of claim 1, wherein the thermal head unit further comprises a converter which converts the received low voltage differential signals into transistor-transistor logic (TTL) level signals.

3. The image forming apparatus of claim 1, wherein the thermal head unit further comprises a converter which converts the low voltage differential signals into complementary metal oxide semiconductor (CMOS) level signals.

4. The image forming apparatus of claim 1, wherein the control unit further comprises a serial converting unit which converts the control signals into serial signals.

5. The image forming apparatus of claim 1, wherein the thermal head unit further comprises a parallel converting unit which converts the control signals into parallel signals.

6. The image forming apparatus of claim 1, wherein the LVDS driver comprises two current sources and two data input ports.

7. The image forming apparatus of claim 1, wherein the LVDS receiver includes three comparators and an OR gate.

8. The image forming apparatus of claim 1, wherein the thermal head unit comprises a plurality of thermal heads which apply heat to the medium according to the control signals.

9. A method of forming an image using an image forming apparatus, the method comprising:
receiving image data of the image that is to be printed;
generating control signals to drive the thermal head based on the image data;
converting the control signals into low voltage differential signals and outputting the low voltage differential signals;
receiving the low voltage differential signals and converting the low voltage differential signals into the control signals; and
printing the image by applying heat onto the medium with the thermal head according to the received control signals.

10. The method of claim 9, further comprising converting the control signals into serial signals.

11. The method of claim 9, further comprising converting the received low voltage differential signals into CMOS level signals.

12. The method of claim 9, further comprising converting the received low voltage differential signals into TTL level signals.

13. The method of claim 9, further comprising converting the received control signals into parallel signals.
